(19) United States
(12) Patent Application Publication
(10) Pub. No.: US 2016/0235078 A1
(43) Pub. Date: Aug. 18, 2016

(54) Universal Barbeque System

(71) Applicants: Ignazio Farina, Elizabeth, NJ (US); Beniamino Farina, Elizabeth, NJ (US); Giuliano Farina, Elizabeth, NJ (US)

(72) Inventors: Ignazio Farina, Elizabeth, NJ (US); Beniamino Farina, Elizabeth, NJ (US); Giuliano Farina, Elizabeth, NJ (US)

(21) Appl. No.: 15/047,544

(22) Filed: Feb. 18, 2016

Related U.S. Application Data
(60) Provisional application No. 62/117,818, filed on Feb. 18, 2015.

(51) Int. Cl. A23B 4/052; A47J 37/07; A47J 37/04

(52) U.S. Cl. CPC A23B 4/052; A47J 37/04; A47J 37/0718; A47J 37/0786

(57) ABSTRACT

A universal barbeque system is provided. The universal barbeque system comprises a housing having an open front side, a grill positionable within the housing, a smoker oven positionable within the housing, a rotisserie positionable within the housing, a pizza oven positionable within the housing, and a fuel source positionable within the housing. Each of the grill, the smoker oven, the rotisserie, and the pizza oven are separately operable independent of each other.

### CLAIM OF PRIORITY

This patent application claims priority under 35 USC 119 (e)(1) from U.S. Provisional Patent Application Ser. No. 62/117,818 filed Feb. 18, 2015, of common inventorship herewith entitled, “Universal BBQ,” which is incorporated herein by reference as though the same were set forth in its entirety.

### FIELD OF THE INVENTION

The present invention pertains to the field of cooking equipment, and more specifically to the field of barbeque grills.

### BACKGROUND OF THE INVENTION

In the warmer months and warmer parts of the country, the backyard grill becomes the kitchen of choice for many cooks. The love of outdoor grilling is a vestige of frontier heritage, reminding one of the open campfire and the open range. Chefs and culinary writers point to the purely gustatory pleasures of char grilled perfectly cooked meats and vegetables as the reason grilling is so exhilarating. And the grill masters themselves might suggest that beyond the unquestionable quality of the food itself, outdoor grilling also gets a cook out of a hot kitchen and into the open air and a convivial, relaxed atmosphere of friends, family and the irresistible sound of sizzling meat.

The prior art has put forth several designs for barbeque grills. Among these are:

U.S. Pat. No. 6,718,966 to Rodney A. Barbour describes a cooking pot which includes a base portion and a removable cover. An annular lip of the pot is formed with at least one vent opening therein. Airflow between ambient and a cooking chamber defined within the pot is adjustable by rotating the cover relative to the base portion. The cooking pot is also multifunctional in that it is operable in any one of a plurality of cooking modes including but not limited to an open charcoal grilling mode, a closed charcoal grilling mode, an externally heated charcoal grilling mode, a grilling and smoking mode, a deep frying mode, a boiling and simmering mode, a steaming mode and oven modes.

U.S. Pat. No. 4,962,697 to Luther L. Farrar describes a pivotable cooker that can be used for smoking food in one position and grilling food in another position. The housing has two open ends and is pivotable about the middle section. When one open end is disposed on top, the grill is constructed so that smoking can take place. Pivoting the grill around the pivot point then allows the cooker to be used for grilling. The slidable components allow smoking and grilling to be performed immediately after the other without danger of burning and the outer housing is made of a plurality of sections that telescopically fit into each other so that a compact device results.

U.S. Pat. No. 4,210,072 to Ivano Pedrini describes an apparatus for heating or cooking food which comprises a plate forming the hot horizontal surface on which the food to be cooked is placed, at least a heating source underlying the plate, a cover above said plate, which defines a mainly closed space. The metal plate has high thermal conductivity. Preferably, the plate has a raised edge effective to circumscribe and define a space for locating and containing the food. The plate may be inverted and the apparatus may be used as an open grill. In this arrangement, heat is transmitted by conduction. The plate is provided with essentially vertically extending passages located, in the perimetral parts of the plate, in section in vertical planes, in such a way that the lower mouth or inlet of said passages fully communicates with the space underlying the plate so that active circulation of superheated air is established between the space underlying the plate and the space above the plate and defined in the inside of said cover. When the plate is inverted, circulation is prevented or strongly hindered, thereby the heat irradiated by the source of heat is transmitted, substantially completely, to and respectively through the planar portion of said plate.

None of these prior art references describe the present invention.

### SUMMARY OF THE INVENTION

It is an object of the present invention to provide a charcoal or wood fired outdoor cooker that combines a grill, a smoker, a rotisserie, and a pizza oven into one easily used appliance.

The present invention is a universal barbeque system. The universal barbeque system comprises a housing having an open front side, a grill positionable within the housing, a smoker oven positionable within the housing, a rotisserie positionable within the housing, a pizza oven positionable within the housing, and a fuel source positionable within the housing. Each of the grill, the smoker oven, the rotisserie, and the pizza oven are separately operable independent of each other.

In addition, the present invention includes a method for constructing a universal barbeque system. The method comprises providing a housing having an open front side, positioning a grill within the housing, positioning a smoker oven within the housing, positioning a rotisserie within the housing, positioning a pizza oven within the housing, positioning a fuel source within the housing, preparing food by separately operating the grill, the smoker oven, the rotisserie, and the pizza oven are independent of each other.

The present invention further includes a universal barbeque system. The universal barbeque system comprises a housing having an open front side, a door for selectively closing the housing, a supply cabinet formed in the housing, a grill positionable within the housing, a smoker oven positionable within the housing, a rotisserie positionable within the housing, a pizza oven positionable within the housing, a fuel source positionable within the housing, a tray slidable into and out of the housing with the position of the tray adjustable in a generally upward and a generally downward manner and configured for holding the fuel source, and a spent fuel collection bin positioned beneath the tray. Each of the grill, the smoker oven, the rotisserie, and the pizza oven are separately operable independent of each other.

### BRIEF DESCRIPTION OF THE DRAWINGS

FIG. 1 shows a prototypical front diagonal view of the present invention in a closed mode of operation.

FIG. 2 shows a prototypical front diagonal view of the present invention in an open mode of operation.

FIG. 3 is a prototypical diagonal left side view of the present invention showing the side support brackets for a rotisserie handle and vertical slot containing an extended hand crank for the rotisserie component.

FIG. 4 is a prototypical diagonal left side view of the present invention showing how the rotisserie turns to flip to the other side by pulling the handle and rotating the handle by 180 degrees and then resetting it back into position.

FIG. 5 is a prototypical front view of the upper portion of the present invention in an opened position showing rotisserie and smoking racks.

FIG. 6 is a prototypical front view of the present invention's lower portion showing a double door cabinet and two collapsible external shelves adjacent to the cabinet doors.

FIG. 7 is a prototypical front view of the upper portion of the present invention in an opened position showing a ceramic or brick arched pizza oven.

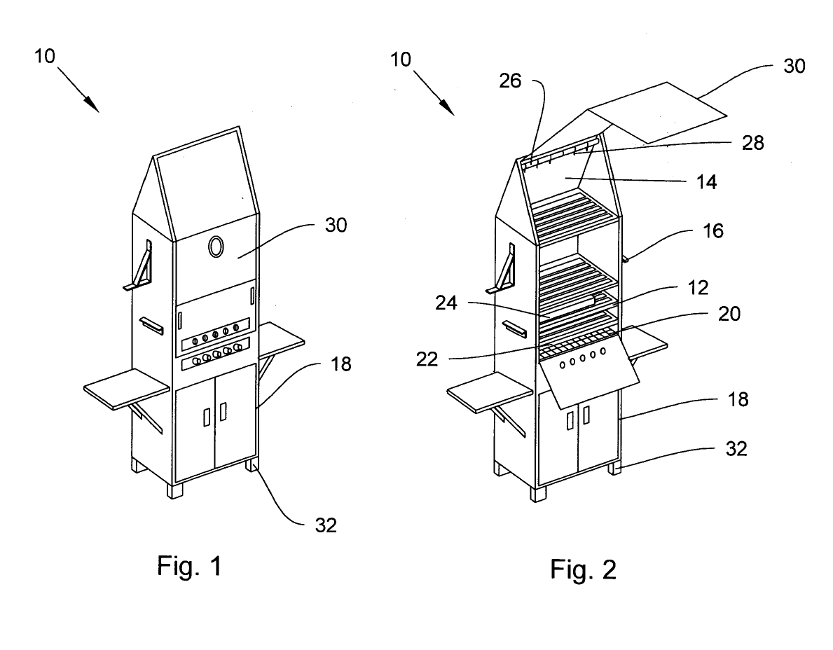

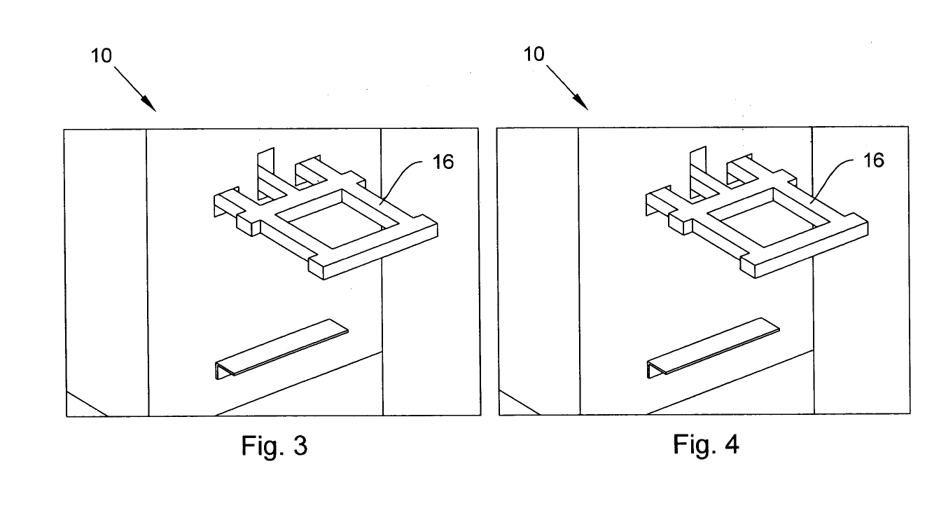

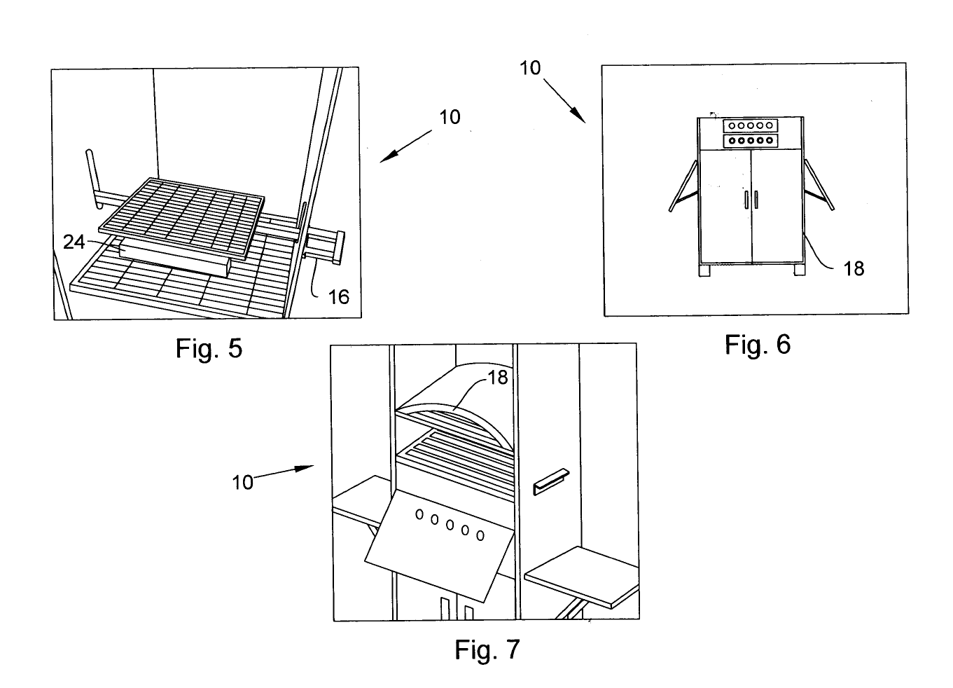

### DETAILED DESCRIPTION OF THE INVENTION

The present invention, hereinafter referred to as the Universal Barbeque System, indicated generally at 10, is a charcoal or wood fired outdoor cooker that combines a grill 12, a smoker oven 14, a rotisserie 16, and a pizza oven 18 into one easily used appliance. In a preferred embodiment, the Universal Barbeque System 10 measures approximately twenty-four inches in width, sixty five inches in height and sixteen inches in depth. Considerably taller than wide, the Universal Barbeque System 10 is constructed in a stacking formation of multiple special purpose compartments. It should be noted that while particular dimensions have been described and illustrated for the Universal Barbeque System 10, it is within the scope of the present invention for the Universal Barbeque System 10 to have greater or smaller dimensions.

The bottom portion of the Universal Barbeque System 10 of the present invention preferably comprises a double door accessory and supplies cabinet 18 suitable for storing charcoal, cooking utensils, spices and similar gear. This cabinet 18 is equipped with at least one, but preferably four, adjustable and side bracket supported shelves. It should be noted that the cabinet 18 is an optional feature and the Universal Barbeque System 10 can be operated without the cabinet 18, if desired.

Above the aforementioned cabinet 18 of the Universal Barbeque System 10 is a slidable bin tray 20 that is preferably equipped with a coiled, stay cool handle. This tray 20 collects ashes and drippings from the charcoal or wood chips burning above it, making their disposal quick, clean and easy.

The next compartment above the slidable tray 20 of the Universal Barbeque System 10 is configured as a four level, height adjustable compartment with a slide in grate 22 for charcoal or wood chips and a slide in stainless steel cooking grill 12. The relative positions of the grate 22 and grill 12 are variable according to the side support brackets selected by the user.

The Universal Barbeque System 10 of the present invention additionally includes a separate, slide in, stainless steel smoker box 24 which functions to contain slow burning wood chips is usable in place of the charcoal grill in the smoker function. The smoker function is preferably located at the very top of the Universal Barbeque System 10 in order to take complete advantage of the rising smoke. The smoker function further consists of a fixed horizontal hanger rod 26 with hooks 28 that provides an optimal and suitable position from which sausage and beefs strip can be hung for smoking.

Furthermore, the Universal Barbeque System 10 of the present invention includes a ceramic or brick pizza oven insert 18. In a preferred embodiment, the pizza oven is constructed as a slide in component. The pizza oven 18 insert is preferably arched in shape although other shapes are within the scope of the present invention. In addition to being used for optimally baked pizza, the pizza oven 18 can be used for other cooking needs which require or need the heat distribution provided by the pizza oven.

Above the top shelf bracket of the four level grilling compartments of the Universal Barbeque System 10 is the rotisserie function 16. A vertical slot on each side of this compartment accommodates a hand cranked rotisserie 16 with a locking basket at several alternate levels from 0 to 180 degrees and back. It should be noted that the Universal Barbeque System 10 can accommodate a motorized rotisserie function 16, if desired.

In sum, the Universal Barbeque System 10 is a self-contained charcoal or wood fired cooker. The Universal Barbeque System 10 enables a backyard chef to smoke meats, roast meats, fish, and poultry on a rotisserie, bake brick oven pizza and grill a variety of meats and vegetable all within the same device. The griller has full control of such essentials as the relative position of heat source and grill, the circulation of smoke and the frequency with which the rotisserie 16 is turned. Everything is accessed easily by a double hinged, sliding pull down hood 30.

One embodiment of the Universal Barbeque System 10 of the present invention is configured to neatly fit into brick fireplaces or fire pits. An alternate embodiment is constructed just as the first embodiment but includes locking fold down stainless steel legs 32 along with a set of retractable dolly type wheels and a pull bar for rolling. Both embodiments are produced in stainless steel, brushed aluminum or enameled aluminum alloy. The Universal Barbeque System 10 is tough, durable, and weatherproof. In a preferred embodiment, the hood 30 slides within a special channel and has an overlapping lip to keep rain from entering the interior of the present invention.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A universal barbeque system comprising:
a housing having an open front side;
a grill positionable within the housing;
a smoker oven positionable within the housing;
a rotisserie positionable within the housing;
a pizza oven positionable within the housing; and
a fuel source positionable within the housing;
wherein each of the grill, the smoker oven, the rotisserie, and the pizza oven are separately operable independent of each other.

2. The universal barbeque system of claim 1 wherein the fuel source is selected from the group consisting of charcoal and wood.

3. The universal barbeque system of claim 1 wherein the housing includes a double door accessory and supplies cabinet suitable at a bottom portion of the housing, the cabinet suitable for storing charcoal, cooking utensils, spices and similar gear.

4. The universal barbeque system of claim 3 wherein the cabinet includes at least one adjustable and side bracket supported shelf.

5. The universal barbeque system of claim 1 and further comprising a spent fuel collection bin having a coiled, stay cool handle for collecting ashes and drippings from the fuel source.

6. The universal barbeque system of claim 1 and further comprising:
a tray slidable into and out of the housing, the position of the tray adjustable in a generally upward and a generally downward manner, the tray configured for holding the fuel source.

7. The universal barbeque system of claim 1 wherein the smoker oven includes a separate, slide in smoker box configured to receive slow burning fuel.

8. The universal barbeque system of claim 7 wherein the smoker oven is positioned at a top of the housing.

9. The universal barbeque system of claim 7 wherein the smoker over includes a fixed horizontal hanger rod with hooks.

10. The universal barbeque system of claim 1 wherein the pizza oven is constructed from a material selected from the group consisting of ceramic and brick.

11. The universal barbeque system of claim 1 wherein the pizza oven is selectively slidable into and out the housing.

12. The universal barbeque system of claim 1 wherein the rotisserie includes a vertical slot on each side of the housing for receiving a hand cranked rotisserie with a locking basket at several alternate levels from 0 to 180 degrees and back.

13. The universal barbeque system of claim 1 wherein the housing is a self-contained cooking device allowing a user to selectively smoke meats and roast meats on a rotisserie, bake pizza, and grill a variety of food products all within a single device.

14. The universal barbeque system of claim 1 and further comprising:
a double hinged, sliding pull down hood mounted to the housing for selectively closing the housing.

15. The universal barbeque system of claim 14 and further comprising:
a channel formed in the housing allowing the hood to slide within the channel;
wherein the hood has an overlapping lip to keep adverse elements from entering the interior of the housing.

16. The universal barbeque system of claim 1 wherein the housing is configured to be received within a fireplace or fire pit.

17. The universal barbeque system of claim 1 and further comprising:
a plurality of locking fold down legs along with a set of retractable dolly type wheels mounted to a bottom surface of the housing; and
a pull bar mounted to the housing.

18. A method for constructing a universal barbeque system, the method comprising:
providing a housing having an open front side;
positioning a grill within the housing;
positioning a smoker oven within the housing;
positioning a rotisserie within the housing;
positioning a pizza oven within the housing;
positioning a fuel source within the housing;
preparing food by separately operating the grill, the smoker oven, the rotisserie, and the pizza oven are independent of each other.

19. A universal barbeque system comprising:
a housing having an open front side;
a door for selectively closing the housing;
a supply cabinet formed in the housing;
a grill positionable within the housing;
a smoker oven positionable within the housing;
a rotisserie positionable within the housing;
a pizza oven positionable within the housing;
a fuel source positionable within the housing;
a tray slidable into and out of the housing, the position of the tray adjustable in a generally upward and a generally downward manner, the tray configured for holding the fuel source; and
a spent fuel collection bin positioned beneath the tray;
wherein each of the grill, the smoker oven, the rotisserie, and the pizza oven are separately operable independent of each other.

20. The universal barbeque system of claim 19 wherein the housing is a self-contained cooking device allowing a user to selectively smoke meats and roast meats on a rotisserie, bake pizza, and grill a variety of food products all within a single device.
